(19) United States
(12) Patent Application Publication
(10) Pub. No.: US 2007/0165899 A1
(43) Pub. Date: Jul. 19, 2007

(54) Audio headphone

(76) Inventor: Matthieu Garin, Paris (FR)

Correspondence Address: YOUNG & THOMPSON, 745 SOUTH 23RD STREET, 2ND FLOOR, ARLINGTON, VA, 22202, US

(21) Appl. No.: 10/586,966

(22) PCT Filed: Jan. 26, 2005
(86) PCT No.: PCT/FR05/00164

§ 371 Date: Jul. 25, 2006

(30) Foreign Application Priority Data
Jan. 29, 2004 (FR) 0400815

(51) Int. Cl. H04R 25/00

(52) U.S. Cl. 381/377; 381/370

(57) ABSTRACT

This headphone (1) includes a headband (2) embodied to surround the head of a user and at least one sound emitter unit (3) arranged to face an ear. Each sound emitter unit (3) includes a mini-loud speaker (7) and a shell (8) concave on one face ; the audio headphone (1) being embodied such that the mini-loud speaker (7) is arranged in front of the ear, without making contact therewith, when the headphone (1) is worn and placed such as to broadcast the sound therefrom in the direction of the auricle of the ear, and such that the shell (8) is fixed to the mini-loud speaker (7), when placed along the auricle of the ear with the concave region thereof facing the auricle.

The invention relates to an audio headphone.

Existing audio headphones consist of sound emission systems that are positioned, either around the ear (“circum-auricular” headphones) or on the auricle of the ear (“mini-headphones”), or in the auditory canal (“auricular” headphones).

The first kind of headphones is used by professionals or with high-fidelity audio systems; the second kind of headphones is mostly used with personal stereo while the third kind of headphones is rather used with personal stereo or mobile (cellular) phones.

The existing devices have several drawbacks.

Indeed, an audio headphone, regardless of its kind, is an external element put in contact with the ear, which is a sensitive part of the body; the contact between this external element and the ear may cause a constraint or even an irritation during extended listening periods.

Furthermore, audio headphones are setting the sound emission directly in contact with, either the auricle of the ear, or inside the auditory canal, while listening at a “natural level” (this means: without headphone) does prompt, in a complementary way, the auricle and the rest of the hearing system; listening with a headphone does not call upon the primary function of the auricle of the ear, this is to say, to capture, to channel the sound as well as to provide a first processing of the sound.

Moreover, current audio headphones fail to provide a positive and cumulative answer to three criteria of selection: lightness, accuracy, comfort/handiness. “Circum-auricular” headphones are indeed stable and comfortable, and they are equipped with a substantial loose diaphragm (transducer) allowing a great acoustic accuracy and a good overall depiction. However, they are heavy and cumbersome. “Mini-headphones” are convenient and light. However, they are irritating the auricle of the ear when used during extended listening periods and their spectrum is poor and narrow. Auricular headphones, as far as they are concerned, are very functional and extremely light. However their audio quality is mediocre, they are very uncomfortable when used during extended listening periods as they imply a contact with the auditory canal.

The aim of the invention is to remedy to these drawbacks, by offering an audio headphone:
which is providing a positive and cumulative answer to the three criteria of selection already mentioned, this means: lightness, accuracy, comfort/handiness;
which is taking advantage of the natural potential of the auricle of the ear;
which is preventing a direct contact between the sound emission source and the auricle of the ear or the auditory canal, or which is preventing too close of a proximity between the sound emission system and the hearing system;
which is meeting a need for comfort and ergonomics;
which is getting closer to a “spatial type” listening quality and while being close, in its properties, to the “natural level” listening (this means without headphone).

The headphone includes, as it is known per se, one headband embodied to surround the head of a user and at least one sound emitter unit, arranged to face an ear.

According to the invention, each sound emitter unit is comprised of one mini-loud speaker and one concave shaped shell on one side; the unit is embodied such that said mini-loud speaker is arrange in front of the ear, without making contact therewith, when the headphone is worn and placed such as to broadcast the sound therefrom in the direction of the auricle of the ear, and such that said shell is fixed to said mini-loud speaker, while being positioned alongside the auricle of the ear, with the concave region thereof facing said auricle.

The headphone according to the invention is therefore neither composed of an interdependent headband with two transmitters that rest, either around the ear thanks to circular pads, or against the auricle of the ear, nor is it composed of sound emitter units that end up being stuck in the auditory canal.

In the headphone according to the invention, each mini-loud speaker finds its position before the ear and the sound that it broadcasts is directed toward the auricle; the shell located in front of the mini-loud speaker is designed to keep the sound broadcast by this mini-loud speaker in within the area of the auricle and to prevent disturbances generated by the surroundings. Said shell is thus going to operate just like a “counter-auricle” in a way that it is going to provide a first sound processing the same way the auricle of the ear naturally does; it is going, therefore, to prepare and distribute the sound to its utmost toward the auricle, taking into consideration its shape and properties, while protecting the sound broadcast by the mini-loud speaker against the external disturbances. Vice versa, the shell enables to isolate the sound in the area of the ear and to prevent a spread of the sound that could disturb the user's surroundings.

Said shell may have the shape of a shellfish, and more precisely, may approximately have the shape of a mussel.

According to the preferred embodiment of the invention, each sound emitter unit is assembled on a ball-and-socket joint that enables the user to adjust it to his/her morphology of the ear.

Preferably, the headband is comprised of a central part embodied to surround the head of a user by exerting a light pressure on his/her cranium, and two lateral portions bent like a glasses side-piece's tip, these lateral portions being shaped to find a stable rest on the mastoid bone, referred to as the “boulder”, when said mini-loud speaker and said shell are properly positioned before and near a ear.

This headband provides a stable and non irritating support for the headphone on a bone area of the head of a user.

Preferably, each mini-loud speaker and each shell is carried by a side-piece linked to the headband. This side-piece may be movable with respect to the headband in order to enable the adjustment of the position of the mini-loud speaker and the shell independently from the position of the headband on the head of a user.

Said central part of the headband may be connected to said lateral portions by articulations enabling to tip said central part against said lateral portions.

The central part of the headband can, thus, be tipped against said lateral portions, enabling the central part to be carried, either on the skull's tip, or on the rear of the head.

Likewise, each shell may be connected to the headband through a ball-and-socket joint, in order to enable the adjustment of its position with respect to the latter.

The expected benefits with the headphone, according to the invention, are as follows:
Ergonomics: the headphone according to the invention does respect the morphology of the ear in the way that it enables preventing the constraint, or even the irritation of the auricle of the ear as well as the one of the auditory canal; the strength and the lack of sensitiveness of the mastoid bone allows a great stability and a great comfort for the user;
Acoustics: the headphone according to the invention enables to move the sound source away from the ear and to call upon the property of the auricle in its primary function which is to capture the sound and to provide the first processing to it; the sound has more “dynamics”, more “elasticity” and more “depth”, being less “crushed” and less “overwhelming”;

harmonics are more elaborate, the headphone centers the voices' tone and the sound appears to be more spontaneous; this headphone does release a spatial value when headphone listening.
Secureness: remaining in half-open circuit, the headphone according to the invention enables the user to stay in touch with the outside world.

A preferred embodiment of the involved headphone is described, hereafter, in reference to the schematic drawings. In the drawings,

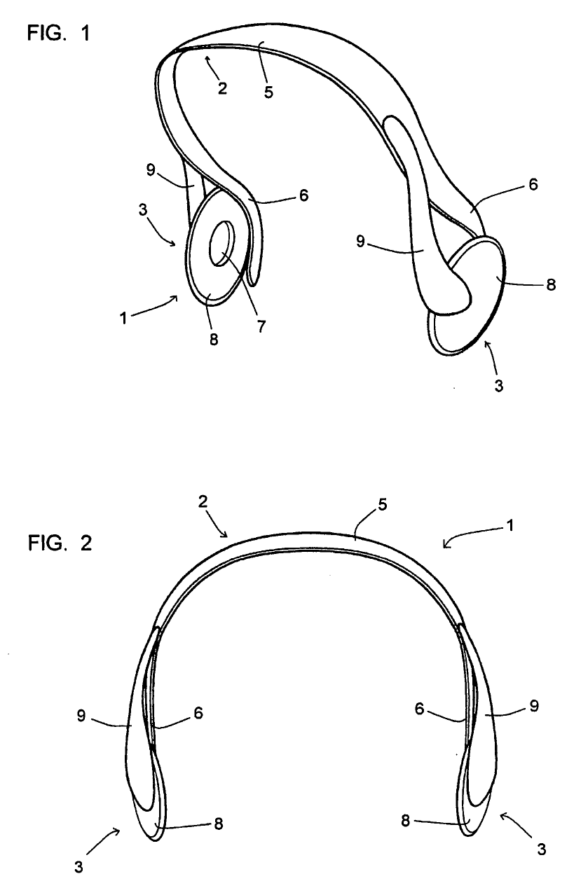

FIG. 1 is a perspective view of this headphone;

FIG. 2 is a front view thereof;

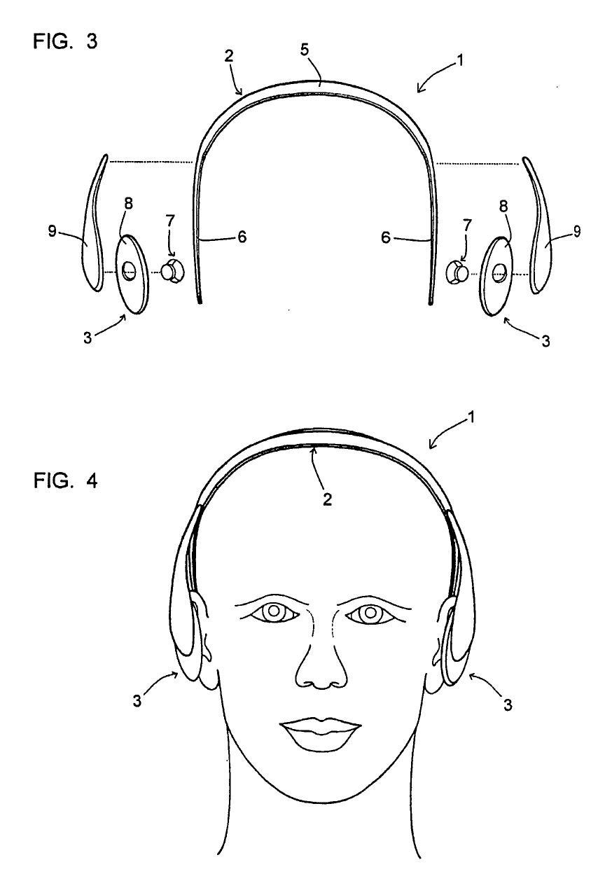

FIG. 3 is an exploded view similar to FIG. 2, and

FIGS. 4 to 6 are, respectively, front, profile and three-quarter views, once the headphone is placed on the head of a user.

FIGS. 1 to 3 represent an audio headphone 1, including a headband 2 embodied to surround the head of a user, and two sound emitter units 3, designed to be positioned before the ears of the user.

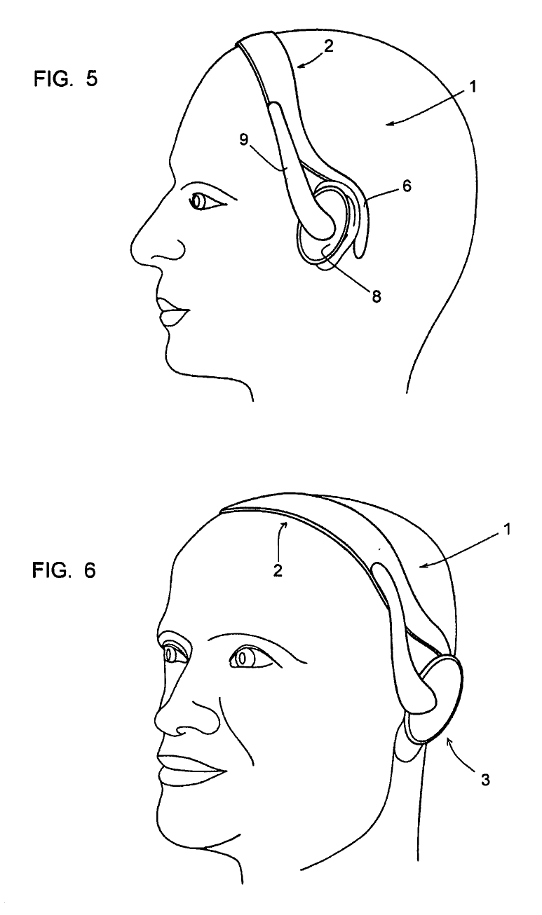

The headband 2 comprises a central part 5 embodied to surround the head of a user, while exerting a light pressure on his/her cranium, and two lateral portions 6 bent like glasses side pieces' tips. As shown in FIGS. 5 and 6, these lateral portions 6 are shaped to find a stable rest on the mastoid bone, referred to as the “boulder” when the units 3 are positioned before the ears of the user.

Each unit 3 includes, as shown more specifically on FIG. 3, a mini-loud speaker 7 and a shell 8 presenting a concavity on one side.

The mini-loud speaker 7 is mounted on the end of a side-piece 9 connected to the lateral area of the central part 5 of the headband 2, and the shell 8 is assembled to the mini-loud speaker 7 in such a way that its concavity is directed toward the user's ear when the headphone 1 is being worn.

As it is shown in reference to FIGS. 4 to 6, the headphone 1 is being put together in such a way that the mini-loud speakers 7 are arranged in front of the ears of the user, without any contact with the latter, when the headphone 1 is worn, and they are placed such as to broadcast a sound toward the auricles of these ears. In this same configuration, the shells 8 are positioned alongside the auricles of the ears.

As it appears from the preceding, the invention provides for an audio headphone that offers many benefits as compared to headphones from previous techniques. Indeed, this headphone provides a positive and cumulative answer to three criteria of selection, this is to say: lightness, accuracy, comfort/handiness, it takes advantage of the natural acoustic potential of the auricle of the ear, it prevents the direct contact between the audible source and the auricle of the ear or the auditory canal, or it prevents too close of a proximity of the sound transmission system and the hearing system, it meets the need for comfort and ergonomics, and it get closer to a “spatial” type listening quality, close to the “natural level” listening (this means without headphone).

It is to be understood that the invention is not limited to the embodiment, as described here above as an example, but it embraces, on the contrary, all variations of execution within the scope of the claims.

1. Audio headphone (1), comprising a headband (2) embodied to surround the head of a user and at least one sound emitter unit (3) arranged to face an ear, wherein each sound emitter unit (3) comprises a mini-loud speaker (7) and a shell (8) concave on one face; the unit (3) is embodied such that said mini-loud speaker (7) is arranged in front of the ear, without making contact therewith, when the headphone (1) is worn and placed such as to broadcast the sound therefrom in the direction of the auricle of the ear, and such that said shell (8) is fixed to said mini-loud speaker (7), when placed along the auricle of the ear with the concave region thereof facing said auricle.

2. Headphone according to claim 1, wherein the shell (8) has approximately the shape of a shellfish.

3. Headphone according to claim 2, wherein the shell (8) has approximately the shape of a mussel.

4. Headphone according to claim 1, wherein each sound emitter unit (3) set is mounted on a ball-and-socket joint.

5. Headphone according to claim 1, wherein the headband (2) includes a central part (5) embodied to surround the head of a user by exerting a light pressure on his/her cranium, and two lateral portions (6) bent like a glasses side-piece's tip, these lateral portions (6) being shaped to find a stable rest on the mastoid bone referred to as the “boulder”, when said mini-loud speaker (7) and said shell (8) are properly positioned near the ears.

6. Headphone according to claim 1, wherein each mini-loud speaker (7) and each shell (8) is carried by a side-piece (9) connected to the headband (2).

7. Headphone according to claim 6, wherein each piece (9) is movable with respect to the headband (2).

8. Headphone according to claim 1, wherein said central part (5) of the headband (2) is connected to said lateral portions (6) of this headband (2) by articulations enabling to tip said central part (5) against said lateral portions (6).

9. Headphone according to claim 1, wherein each shell is connected to the headband by a ball-and-socket joint.

10. Headphone according to claim 2, wherein each sound emitter unit (3) set is mounted on a ball-and-socket joint.

11. Headphone according to claim 3, wherein each sound emitter unit (3) set is mounted on a ball-and-socket joint.

12. Headphone according to claim 2, wherein the headband (2) includes a central part (5) embodied to surround the head of a user by exerting a light pressure on his/her cranium, and two lateral portions (6) bent like a glasses side-piece's tip, these lateral portions (6) being shaped to find a stable rest on the mastoid bone, referred to as the “boulder”, when said mini-loud speaker (7) and said shell (8) are properly positioned near the ears.

13. Headphone according to claim 3, wherein the headband (2) includes a central part (5) embodied to surround the head of a user by exerting a light pressure on his/her cranium, and two lateral portions (6) bent like a glasses side-piece's tip, these lateral portions (6) being shaped to find a stable rest on the mastoid bone, referred to as the “boulder”, when said mini-loud speaker (7) and said shell (8) are properly positioned near the ears.

14. Headphone according to claim 4, wherein the headband (2) includes a central part (5) embodied to surround the head of a user by exerting a light pressure on his/her cranium, and two lateral portions (6) bent like a glasses side-piece's tip, these lateral portions (6) being shaped to find a stable rest on the mastoid bone, referred to as the “boulder”, when said mini-loud speaker (7) and said shell (8) are properly positioned near the ears.

15. Headphone according to claim 2, wherein each mini-loud speaker (7) and each shell (8) is carried by a side-piece (9) connected to the headband (2).

16. Headphone according to claim 3, wherein each mini-loud speaker (7) and each shell (8) is carried by a side-piece (9) connected to the headband (2).

17. Headphone according to claim 4, wherein each mini-loud speaker (7) and each shell (8) is carried by a side-piece (9) connected to the headband (2).

18. Headphone according to claim 5, wherein each mini-loud speaker (7) and each shell (8) is carried by a side-piece (9) connected to the headband (2).
